(19) United States
(12) Patent Application Publication
(10) Pub. No.: US 2023/0174907 A1
(43) Pub. Date: Jun. 8, 2023

(54) MULTI-TIER VESSEL BREWING SYSTEM AND METHOD THEREOF

(71) Applicant: Blichmann Engineering, LLC, Lafayette, IN (US)

(72) Inventors: John R. Blichmann, Lafayette, IN (US); Preston Voglund, Brook, IN (US)

(21) Appl. No.: 18/074,327

(22) Filed: Dec. 2, 2022

Related U.S. Application Data
(60) Provisional application No. 63/285,479, filed on Dec. 2, 2021.

(51) Int. Cl. C12C 7/06; C12C 7/17; C12C 7/20

(52) U.S. Cl. CPC C12C 7/06; C12C 7/17; C12C 7/20

(57) ABSTRACT

A brewing apparatus comprising a first vessel having a top end having a top edge, a bottom end, an interior portion having an interior side wall, an exterior side wall. The brewing apparatus further comprises a secondary vessel having a top end having a top edge, a bottom end, an interior portion having an interior side wall, an exterior side wall, wherein the secondary vessel is configured to fit in the interior portion of the first vessel, wherein the secondary vessel includes a first row of one or more coupling members positioned along a first plane between the top edge and the bottom edge of the secondary vessel, wherein the coupling means are coupled to the exterior sidewall of the secondary vessel.

### CROSS-REFERENCE TO RELATED APPLICATION

This U.S. patent application claims priority to U.S. Provisional Application 63/285,479 filed Dec. 2, 2021, the disclosure of which is considered part of the disclosure of this application and is hereby incorporated by reference in its entirety.

### FIELD OF INVENTION

This invention relates generally to a system and apparatus for mashing grain into a fermentable sugar, and more specifically and multi-tiered apparatus.

### BACKGROUND

It is well known in the art to use a 3-tier system to produce beer wort from crushed grains. A typical system utilizes a first vessel for boiling the finished wort. A second vessel called a mash and lauter tun for mashing the grains which will contain a false bottom or a slotted pipe manifold or a simple screen on the drain fitting. A third vessel called a hot liquor tank (HLT) is simply a tank for heating the rinse water for the spent grains. Although uncommon, sometimes a combined mash lauter tun is not used and the wort is transferred from the mash tun to the lauter tun for wort (unfermented beer) separation. To prepare the wort, the mash tun is filled with a preestablished quantity of water and heated to a preestablished temperature. Typically, a water to grist ratio of 1 to 2 quarts of water per pound of grain is used. The crushed grains are then placed in the tun and allowed to rest for a period of time which allows the starches in the grains to convert to sugars. At the same time, the HLT is filled and heated to a preestablished temperature. After the mash rest is completed, the contents of the mash tun are drained into a grant (a smaller pot) and returned to the top of the mash. This is repeated until the wort runs clear, and in the art is called a vorlauf or simply “setting the mash bed”. This step will allow the mash to act as the filter media for the wort, thus, clarifying the wort. The clarified wort is then directed to the brew kettle. Simultaneously, a sparging process is begun by draining the HLT water into the top of the mash tun thereby rinsing the remaining sugars out of the grains and into the brew kettle.

For best efficiency it is known in the art that this process should take about an hour to perform. A rate much faster than this and extraction efficiency suffers. After the sparging process, a clear wort is drained into the brew kettle since nearly all sugars have been removed from the mashed grains. As a result, traditional 3 tier systems product a very clear wort free of undesirable proteins and do so with excellent efficiencies. Their main drawback is the extended amount of time needed to prepare the wort due to the clarification and sparging process. Additionally, brewers have a difficult time controlling temperatures in the mash tun to produce the desired wort sugar consistency. Therefore, it is quite common to utilize a Recirculation Infusion Mash System (RIMS) in the mashing process for the preparation of beer wort which is well known in the art.

A common variant of the traditional RIMS is to use a heat exchanger instead of directly applying heat. These systems are referred to as “Heat Exchanger Recirculation Mash Systems” or HERMS. Such systems utilize a mash tun which contains a false bottom or other filter system (screens, slotted pipe manifold to name a few). The wort is drawn off the bottom of the pot, then directly heated via an electric, gas or other heat sources and returned to the top of the mash. It is common to recirculate via a pump but gravity draining into a second container and manually returning the wort to the top of the mash is also common. HERMS systems indirectly heat the wort through a heat exchanger usually immersed to the hot liquor tank. This reduces the chances of scorching the wort which adds undesirable flavor and colors to the finished wort. When the preestablished rest temperature is reached the heater (or pump in the case of a HERMS system) is turned off. Also, very common are numerous electronic control systems to automatically turn the pumps/heat on and off to maintaining a preestablished rest temperature, typically employing a temperature sensor and a meter, PID, PLC, switch or similar to turn on/off modulate the heat source to maintain preestablished temperature and, if desired, ramp to numerous temperatures throughout the mashing process.

The “Brew in a Bag” (BIAB) method is also well known in the art to produce wort in an all-grain system. The BIAB system are quite simple and are becoming more popular in the industry because of their ease of use, although they do have some deficiencies. Namely, lack of wort clarification and poor efficiency. In lieu of a pot and a false bottom. A porous bag filled with crushed grains is placed in a pot of heated water of a predetermined volume and allowed to steep for a preestablished time. Typical water to grist ratios are 2-3 quarts per pound of grain. Noting, higher ratios may not be achieved since the grains consume a significant portion of the total volume of the mash and is limited by the size of the pot. This would require an oversized pot with a less than optimum size for good boil characteristics once the spent grains are removed. After this time has passed the bag is lifted and allowed to drain back into the pot. While the advantages of simplicity, low cost, and speed are clear and obvious advantages, there are equally clear disadvantages to the BIAB system. Firstly, the elimination of recirculation precludes the clarification of the wort from the grains acting as a filter media and the resulting worts are significantly cloudier than those of 3 tier type systems and contain undesirable proteins and particulate matter which negatively impact beer quality. Secondly, it is not possible to readily perform a step mash (resting at various temperatures) since the bag impedes the heating action and leads to scorching. This precludes the brewer from making certain beer styles since they require multiple temperature rests. Therefore only beers capable of being brewed in a simple step infusion mash are suitable of being brewed in a BIAB system. Thirdly, significant quantities of wort sugars remain in the spent grains since the sparging process described above is eliminated, and the wort is more concentrated than the present invention. Therefore cloudy wort with significantly lower efficiency (more grain is required to produce the finished beer) are produced with BIAB systems. And lastly, the brewer must lift the hot bag of spent grains above the brew kettle to drain out the contained wort. This a cumbersome, heavy and a dangerous operation.

There exists a need for an all-in-one brewing system that allows a user to easily complete all the necessary brewing steps in a contained brewing system without the need of external lifts and hoists after the mash cycle. The present invention is directed to overcome one or more of the problems as set forth above.

### BRIEF SUMMARY OF THE INVENTION

In one aspect, this disclosure is related to a brewing apparatus comprising a first vessel having a top end having a top edge, a bottom end, an interior portion having an interior side wall, an exterior side wall. The brewing apparatus further comprises a secondary vessel having a top end having a top edge, a bottom end, an interior portion having an interior side wall, an exterior side wall, wherein the secondary vessel is configured to fit in the interior portion of the first vessel, wherein the secondary vessel includes a first row of one or more coupling members positioned along a first plane between the top edge and the bottom edge of the secondary vessel, wherein the coupling means are coupled to the exterior sidewall of the secondary vessel.

In another aspect, the present disclosure relates to a brewing apparatus having a first vessel having a top end having a top edge, a bottom end, an interior portion having an interior side wall, an exterior side wall. The apparatus can further include a secondary vessel having a top end having a top edge, a bottom end, an interior portion having an interior side wall, an exterior side wall. The secondary vessel can be positioned within the interior portion of first vessel at a first position. The secondary vessel can include a first row of one or more coupling members coupled to the exterior side wall of the secondary vessel along a first plane between the top edge and the bottom edge of the secondary vessel. The coupling means at the first plane can interface with the top edge of the first vessel when the secondary vessel is moved from the first position to a second position. A second row of at least one coupling members coupled to the exterior side wall of the secondary vessel along a second plane between the first row of the coupling members and the top edge of the secondary vessels. The coupling means at the second plane can interface the top edge of the first vessel when the secondary vessel is moved from the second position to a third position.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1A is a side view of an exemplary embodiment of a secondary vessel of a brewing apparatus of the present disclosure.

FIG. 1B is a side view of an exemplary embodiment of a secondary vessel of a brewing apparatus of the present disclosure.

FIG. 1C is a perspective view of an exemplary embodiment of a secondary vessel of a brewing apparatus of the present disclosure.

FIG. 1D is a top view of an exemplary embodiment of a secondary vessel of a brewing apparatus of the present disclosure.

FIG. 1E is a close-up view of a support member of FIG. 1C.

FIG. 2A is a top view of an exemplary embodiment of a first brewing vessel having a support ring installed proximate to the top edge of the first vessel of the present disclosure.

FIG. 2B is a perspective view of an exemplary embodiment of a brewing vessel having a racking ring installed proximate to the top edge of the vessel of the present disclosure.

FIG. 3A is a perspective view of a grain basket resting on the support ring of the vessel of an exemplary embodiment of a brewing apparatus of the present disclosure.

FIG. 3B is a close-up to perspective view of a secondary vessel of FIG. 3B resting on the support ring of the vessel of an exemplary embodiment of a brewing apparatus of the present disclosure.

FIG. 4 is a perspective view of an exemplary embodiment of a secondary vessel of the present disclosure.

FIG. 5A is a perspective view of an exemplary embodiment of a grain basket removably coupled at a first position to the vessel of the brewing apparatus of the present disclosure.

FIG. 5B is a perspective view of an exemplary embodiment of a grain basket removably coupled at a second position to the vessel of the brewing apparatus of the present disclosure.

FIG. 5C is a perspective view of an exemplary embodiment of a grain basket removably coupled at a third position to the vessel of the brewing apparatus of the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention. As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

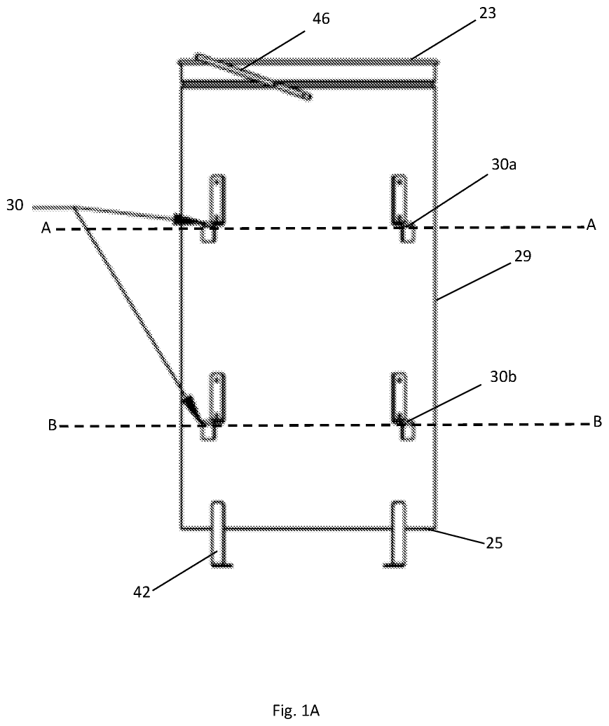

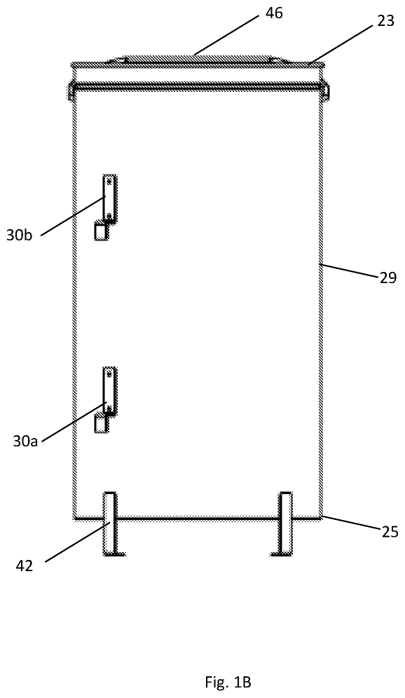

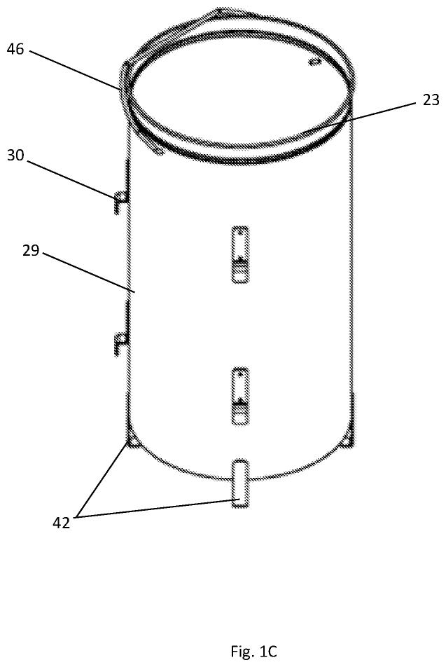

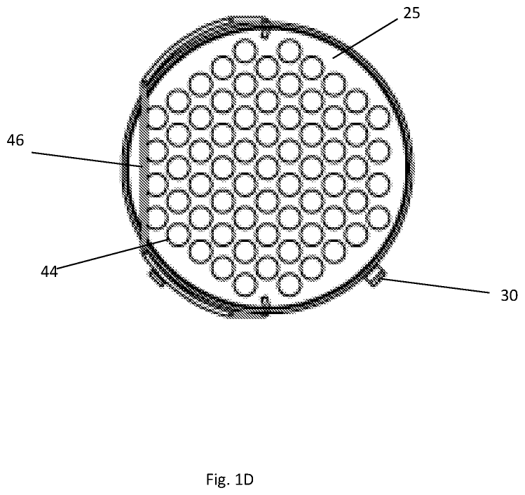

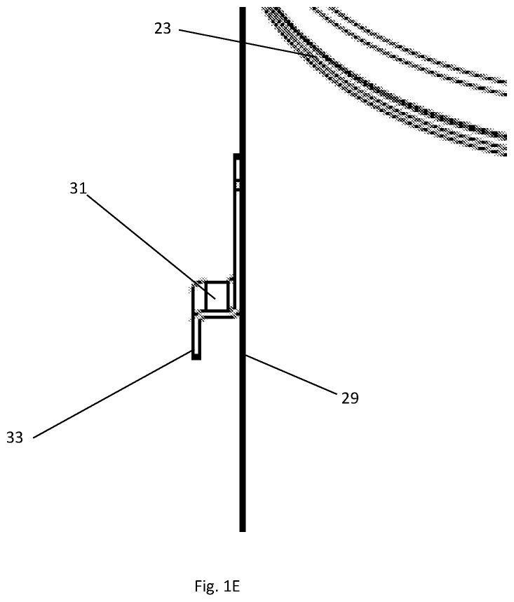

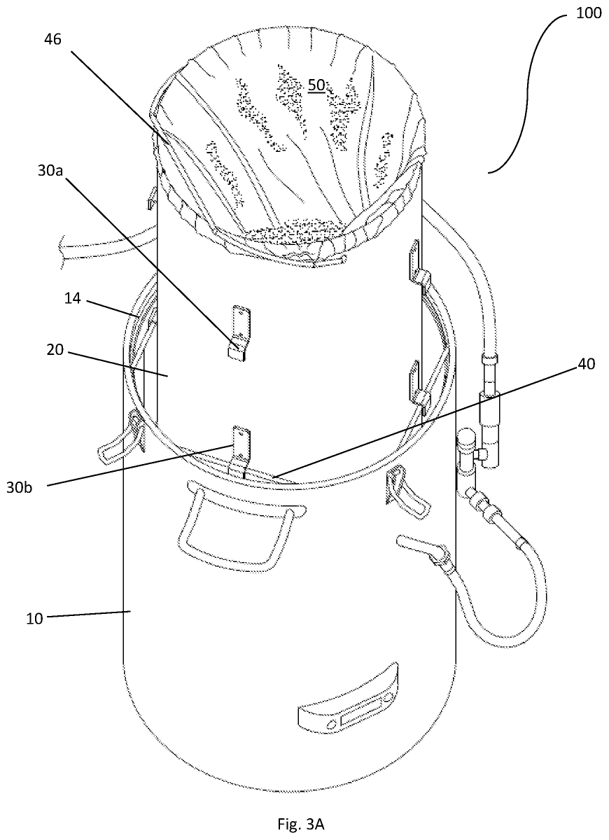

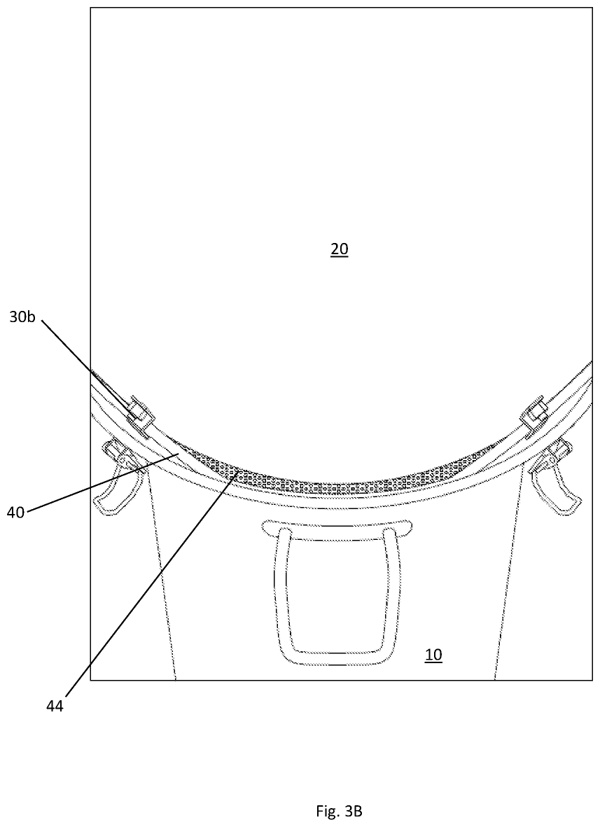

FIGS. 1-5 provide a brewing apparatus of the present disclosure that can allow a user to easily complete all the necessary brewing steps in a contained brewing system without the need of external lifts and hoists after the mash cycle. As shown in FIGS. 3A-B and 5A-5B, the brewing apparatus can include a first vessel 10. The first vessel 10 can have a top end 11 with a top edge 13, a bottom end 15, an interior portion having an interior side wall 17, an exterior side wall 19. The brewing apparatus 100 of the present disclosure can further include a secondary vessel 20. As shown in FIGS. 1A-1E, a secondary vessel 20 can be a grain basket. The secondary vessel 20 can have a top end 21 having a top edge 23, a bottom end 25, an interior portion having an interior side wall 27, and an exterior side wall 29. As shown in FIGS. 3-5, the secondary vessel 20 can be configured to fit in the interior portion of the first vessel 10.

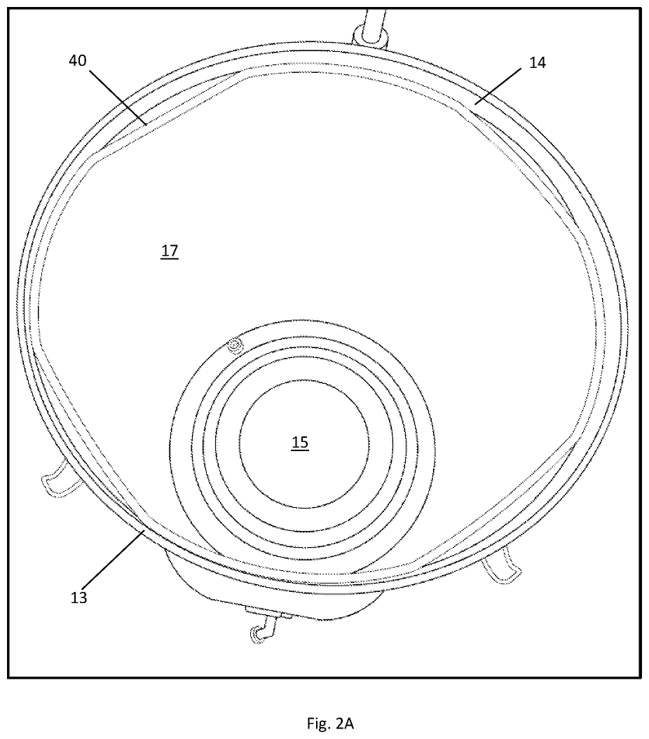

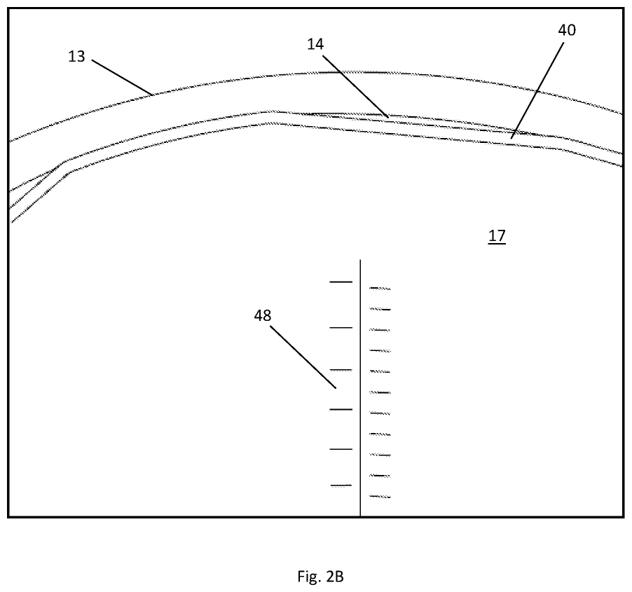

FIG. 1A illustrates an exemplary embodiment of a secondary vessel 20 includes a first row of one or more removable coupling members/brackets 30 positioned along a first plane (A-A) between the top edge 23 and the bottom edge 25 of the secondary vessel 20, wherein the coupling member 30 can be coupled to the exterior sidewall 29 of the secondary vessel 20. As shown in FIG. 2B, the sidewall 17 can have metered numbering scale 48 etched, engraved, or otherwise disposed on the sidewall 17 to provide a user with easer in determining the amount of liquid in the vessel 10. In some exemplary embodiments, the secondary vessel 20 can further include a second row of one or more removable coupling members/brackets 30b positioned along a second plane (B-B) between the first row of one or more coupling members 30a and the top edge 21 of the secondary vessel 20.

In some exemplary embodiments, one or coupling members 30 can be coupled to or formed on the sidewall 29 using any suitable means, including but not limited to welding, riveting, mechanically fastener, or any other suitable means. As shown in FIG. 1E, a coupling member 30 can have a first portion 31 that extends generally perpendicular a predetermined distance from the sidewall 29 of the vessel 20. In some exemplary embodiments, a second portion 33 can extend generally perpendicularly downward from the first portion 31.

As shown in FIGS. 2A-2B, in some exemplary embodiments the brewing apparatus 100 can include a support ring 40 configured to be positioned proximate to the top edge 13 of the first vessel 10. Additionally, some embodiments of the first vessel can include a lip 14 formed in the interior sidewall 17 and extends a pre-determined distance within the interior portion of the vessel 10, wherein the support ring 40 can be positioned and rest on top of the lip 14. The support ring 40 can take any suitable shape including but not limited to an oval, rectangular, hexagonal, or octagonal shape. The support ring 40 can allow a user to lift and rest the secondary vessel 20 on the support ring 40 rather than to the lip of the first vessel 10. In some embodiments, this can help maintain the vessel 20 more uniformly in a balanced/linear position with respect to the first vessel 10 and similarly allow the brewing apparatus 100 to maintain a better center of gravity. In some exemplary embodiments, the diameter of the top lip/edge 13 of the first vessel 10 can be grater than the diameter of the interior lip 14 allowing the support member 40 to be removably positioned lip 14. In some other embodiments, the secondary vessel 20 can have one or more small grooves formed 24 into the exterior side wall 29 to accept a support member 40 that can be removably coupled to the groove 24 to all the secondary vessel to be raised into a secondary position to allow at least a portion of the liquid to drain from the secondary vessel 20 in the first vessel 10.

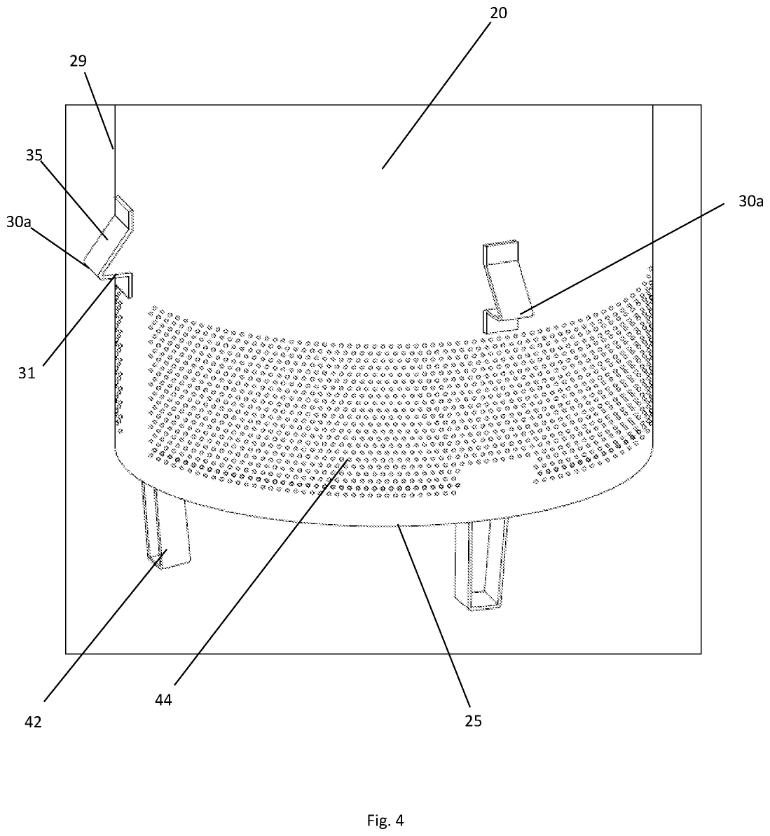

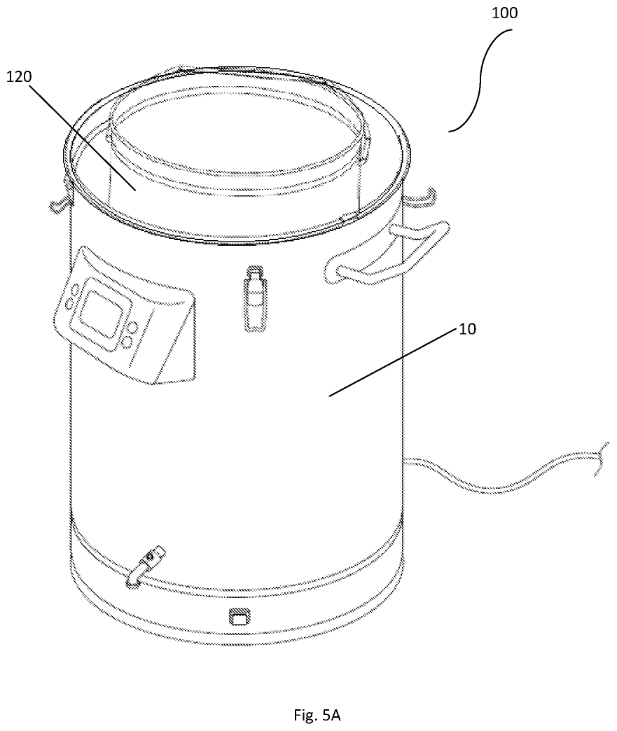

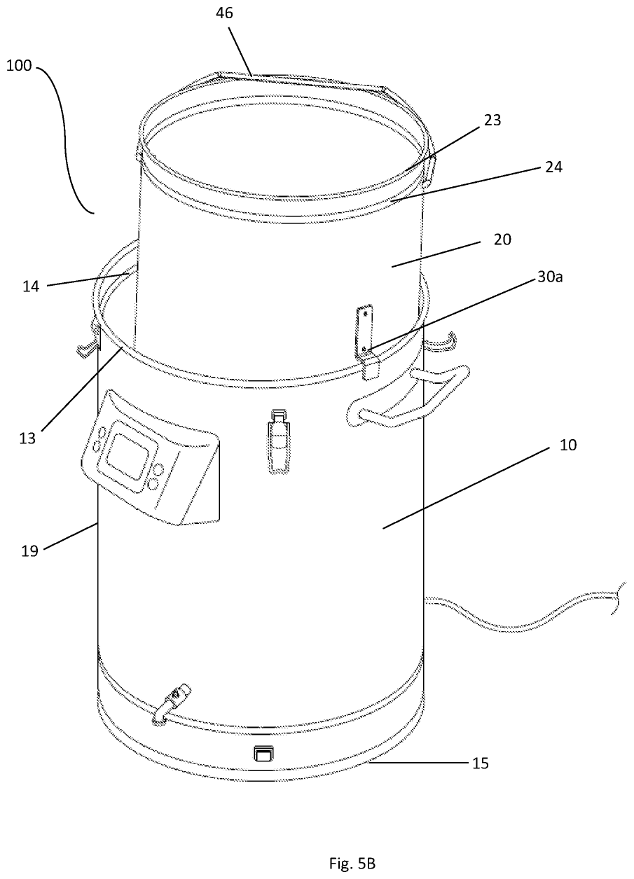

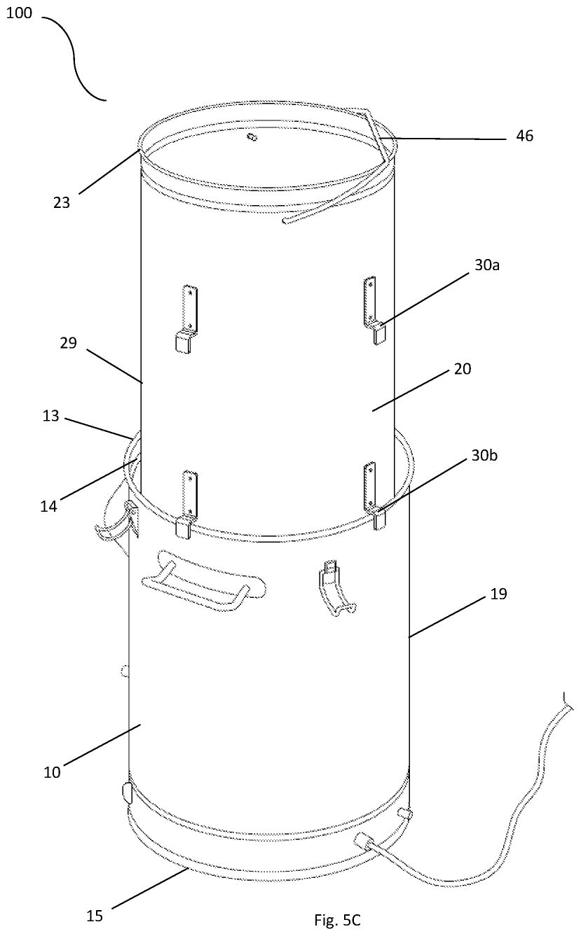

As shown in FIG. 4, alternate exemplary embodiments can include a support portion 35 that can extend upward from the end of the first portion 31 at an angle and couple to the sidewall 29 to provide additional support to the first portion 31 of the coupling member 30. The first portion 31 can be generally flat to allow the first portion to rest upon the support ring 40 or edge 13 of the primary vessel. In some exemplary embodiments utilizing a support ring 40, the secondary vessel can have at least three coupling members 30 along at least one plane to interface with the support ring 40 when lifted to the first position. The three support members can be evenly spaced along the exterior sidewall 29 of the secondary vessel. In another exemplary embodiments utilizing a support ring 40, the secondary vessel 20 can have four coupling members evenly spaced around the exterior vessel wall 29 along first plane and optionally the second plane. The four coupling members 30 allow for even distribution of the load when resting upon the support ring 40. As illustrated in FIGS. 5A-C, the brackets/coupling members 30 can be configured to allow the secondary vessel 20 to rest on the top edge 13 of the first vessel 10 at the first plane and second plane of the secondary vessel 20 where the coupling members 30 are located. In other exemplary embodiments, the coupling members 30 can rest on a support ring 40 that can be positioned proximate to or at the top end of the first vessel 10.

The dual plane nature of the orientation of the coupling members 30 can allow for easier draining and movement of the secondary vessel 20 within the first vessel 10, when the contents of the secondary vessel 20 need to be drained as a user would only have to lift the secondary vessel 20 a first distance to the first plane A-A, which can be about half the distance than would be ordinarily required. Additionally, exemplary embodiments utilizing the dual plane coupling members 30 allow for greater ease by only requiring a user to lift about half of the weight to get the secondary vessel 20 to the brackets on the first plane A-A and allowing at least a portion of a liquid within the secondary vessel 20 to drain and then allowing the user to them lift the secondary vessel 20 to the second plane B-B.

Additionally, the present disclosure provides a method for allowing a user to heat a wort to a biol while the secondary vessel is in a first position (FIG. 5A) within the first vessel 10, wherein the bottom edge 25 of the secondary vessel or alternative the support members 42 can rest on the bottom portion within the first vessel 10. A user can then lift the secondary vessel 20 up to the first plane A-A and rest the coupling members 30 on the first vessel 10 to allow liquid to drain from the secondary vessel 20 through one or more apertures 44 at the bottom of the vessel 20 at a second position (FIG. 5B). In one exemplary embodiment, a user can lift the secondary vessel 20 up out of the first vessel 10 a first predetermined distance to allow a portion of the liquid to drain from the secondary vessel 20. The user can then optionally lift the secondary vessel 20 up to rest the coupling members at a third position (FIG. 5C) at the second plane B-B wherein the bottom of the secondary vessel 20 is positioned above the bottom of the first vessel 10 to further allow any remaining liquid within the secondary vessel 20. A user then can remove the secondary vessel 20 completely out of the first vessel 10. As shown in FIGS. 1A-D, the secondary vessel 20 can optionally include a handle 46 to allow a user the ability to easily lift the secondary vessel 20 from the first vessel 10. The handle 46 can be coupled to the secondary vessel 20 using any suitable means.

In some exemplary embodiments, the first predetermined distance can be the distance between the first plane A-A and the top edge 13 of the primary vessel 10 or a support ring 40 as shown in FIGS. 2-3. The second predetermined distance can be the distance between the second plane B-B and the top edge of the primary vessel or a support ring. In brewing applications, the multi-plane coupling members can allow for the liquid above the level of the wort in a kettle to drain out and reduce the weight of the remaining contents of the secondary vessel 20. After resting for a period of time a user can then lift the secondary vessel to the second set of one or more brackets on the second plane B-B to allow any remaining liquid to drain from the secondary vessel 20. In some embodiments, the brewing system can further utilize a porous bag 50 within the secondary vessel to help limit any the amount of crushed grain migration into the wort.

Furthermore, the secondary vessel of the brewing apparatus can further include one or more support member 42 coupled to the bottom end 25 of the secondary vessel 20 as shown in FIGS. 1A-C and FIG. 4. The support members 42 can be configured to maintain a predetermined distance between the bottom end 13 of the first vessel and the bottom end of the second vessel 23 when the second vessel is positioned within the first vessel. In some exemplary embodiments, the secondary vessel/grain basket can include one or more apertures 44 to allow a liquid to escape the interior portion of the grain basket. The apertures can be located in any suitable location, including but not limited to a portion of the sidewall 29 (FIG. 4) of the secondary vessel or located on the bottom of the secondary vessel (FIG. 1D).

As described herein, one or more brackets/coupling members 30 can be located on a first plane A-A of a secondary vessel, such as a grain basket, and an additional set of one or more coupling member 30 along the second plane B-B of the secondary vessel 20. The brackets 30 can allow a user to lift the basket half way up to a generally mid-located (second plane) brackets and rest the basket on the lip of the boil kettle letting the contents of the secondary vessel to drain from the one or more apertures 44 located on the sidewall and/or the bottom of the secondary vessel to drain for a period of time until the wort level in the basket drops to that of the level in the main boiler as shown in FIG. 4. At that time the user can then lift the grain basket 20 up to the lower set of support brackets 30 on the first plane and let the remaining wort drain. The additional brackets 30 provide advantage in that the user is always lifting approximately half the weight of the contents in the grain basket at a time thereby increasing the safety and capability of one person to lift without an overhead lifting mechanism. The secondary vessel 20 can include a plurality of coupling members along each plane to provide greater flexibility to a user. It should be understood that additional planes of coupling members can also be added to further aid in alleviating the weight of the secondary vessel as it is lifted.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A brewing apparatus comprising:
a first vessel having a top end having a top edge, a bottom end, an interior portion having an interior side wall, an exterior side wall; and
a secondary vessel having a top end having a top edge, a bottom end, an interior portion having an interior side wall, an exterior side wall, wherein the secondary vessel is configured to fit within the interior portion of the first vessel, wherein the secondary vessel includes a first row of one or more coupling members positioned along a first plane between the top edge and the bottom edge of the secondary vessel, wherein the coupling members are coupled to the exterior sidewall of the secondary vessel.

2. The brewing apparatus of claim 1, wherein the secondary vessel further comprises a second row of at least one coupling members positioned along a second plane between the first row of the coupling members and the top edge of the secondary vessels.

3. The brewing apparatus of claim 1, wherein the coupling means interface the top edge of the first vessel when the secondary vessel is moved from a first position to a second position.

4. The brewing apparatus of claim 2, wherein the secondary vessel further comprises a plurality of support members coupled to the bottom end of the secondary vessel, wherein the support members maintain a predetermined distance between the bottom end of the first vessel and the bottom end of the second vessel within the first vessel.

5. The brewing apparatus of claim 2, wherein the sidewall of the secondary vessel further comprises one or more apertures configured to allow liquid to drain out of the interior portion of the secondary vessel.

6. The brewing apparatus of claim 2, wherein the bottom portion of the secondary vessel further comprises one or more apertures configured to allow a liquid to drain out of the interior portion of the secondary vessel into the first vessel.

7. The brewing apparatus of claim 1, further comprising a support ring configured to be positioned proximate to the top lip of the first vessel.

8. The brewing apparatus of claim 7, wherein the first vessel further comprises lip formed in the interior sidewall and extends a pre-determined distance within the interior portion of the vessel, wherein the support ring is positioned to rest on top of the lip of the first vessel.

9. The apparatus of claim 7, wherein the support ring comprises octagonal.

10. The apparatus of claim 7, wherein the support ring is hexagonal.

11. A brewing apparatus configured to fit within a vessel, wherein the brewing apparatus comprises:
a top end having a top edge, a bottom end, an interior portion having an interior side wall, an exterior side wall, wherein the secondary vessel is configured to fit in the interior portion of the first vessel, wherein the secondary vessel includes a first row of one or more coupling members positioned along a first plane between the top edge and the bottom edge of the secondary vessel, wherein the coupling means are coupled to the exterior sidewall of the secondary vessel.

12. The apparatus of claim 11, The brewing apparatus of claim 1, wherein the secondary vessel further comprises a second row of one or more coupling members positioned along a second plane between the first row of one or more coupling members and the top edge of the secondary vessels.

13. The apparatus of claim 11, wherein the coupling means are configured allow the secondary vessel to rest on a top edge of the vessel.

14. The apparatus of claim 12, wherein the brewing apparatus further comprises one or more support member coupled to the bottom end of the secondary vessel, wherein the support members are configured to maintain a predetermined distance between the bottom end of the first vessel and the bottom end of the brewing apparatus.

15. The apparatus of claim 12, wherein the sidewall of the brewing apparatus further comprises one or more apertures configured to allow liquid to drain out of the interior portion of the brewing apparatus.

16. A brewing apparatus comprising:
a first vessel having a top end having a top edge, a bottom end, an interior portion having an interior side wall, an exterior side wall; and
a secondary vessel having a top end having a top edge, a bottom end, an interior portion having an interior side wall, an exterior side wall, wherein the secondary vessel can be positioned within the interior portion of first vessel at a first position, wherein the secondary vessel includes:
a first row of one or more coupling members coupled to the exterior side wall of the secondary vessel along a first plane between the top edge and the bottom edge of the secondary vessel, wherein the coupling means at the first plane interface the top edge of the first vessel when the secondary vessel is moved from the first position to a second position; and
a second row of at least one coupling members coupled to the exterior side wall of the secondary vessel along a second plane between the first row of the coupling members and the top edge of the secondary vessels, wherein the coupling means at the second plane interface the top edge of the first vessel when the secondary vessel is moved from the second position to a third position.

17. The brewing apparatus of claim 16, wherein the brewing apparatus further comprises one or more support member coupled to the bottom end of the secondary vessel, wherein the support members are configured to maintain a predetermined distance between the bottom end of the first vessel and the bottom end of the brewing apparatus.
